(19) United States
(12) Patent Application Publication
(10) Pub. No.: US 2017/0259448 A1
(43) Pub. Date: Sep. 14, 2017

(54) SLICING DEVICE

(71) Applicant: WEBER MASCHINENBAU GmbH BREIDENBACH, Breidenbach (DE)

(72) Inventors: Tobias Weber, Biedenkopf-Wallau (DE); Jörg Schmeiser, Wiggensbach (DE)

(73) Assignee: WEBER MASCHINENBAU GmbH BREIDENBACH, Breidenbach (DE)

(21) Appl. No.: 15/508,734

(22) PCT Filed: Sep. 1, 2015
(86) PCT No.: PCT/EP2015/069953

§ 371 Date: Mar. 3, 2017

(30) Foreign Application Priority Data
Sep. 5, 2014 (DE) 10 2014 112 800.1

(51) Int. Cl. B26D 7/06; B26D 7/30; B26D 7/32; B26D 7/18

(52) U.S. Cl. CPC B26D 7/0625; B26D 7/0683; B26D 7/18; B26D 7/30; B26D 7/32; B26D 2210/02

(57) ABSTRACT

The invention relates to a method for continuously slicing products, in particular food products, comprising at least one slicing unit, in particular comprising a circular or sickle knife, for separating the product into product slices, a feed device for feeding the products to the slicing unit along multiple tracks and a discharge device for discharging portions which respectively comprise at least one separated product slice, the feed device comprises a loading device which is designed to receive at least one product and can be adjusted as a whole between the loading station and a guide station, at least one conveying device which when seen from the direction of guiding, is arranged downstream from the loading device and comprises at least two conveying tracks and a control device which is designed to control the conveying tracks independently from each other such that portions are produced continuously, in which the separation of product slices in a conveying track is interrupted and in particular, almost at the same time, is started with the separating of product slices into another conveying track.

The invention relates to an apparatus and to a method for a continuous slicing of products, in particular food products, for example of sausage, ham, cheese or the like. The slicing apparatus, in particular a slicing apparatus for assorted slices, can preferably be a high-performance slicer. The slicing apparatus comprises at least one slicing unit, in particular having a rotating circular blade or scythe-like blade or one that rotates in a planetary motion, that cuts off product slices and comprises a supply apparatus for a multi-track supply of products to the slicing apparatus. The supply apparatus comprises a loading apparatus that is also called a loading pinion, that is configured for receiving at least one product and that is adjustable between a loading position and a supply position. In the loading position, the loading apparatus can in particular be oriented horizontally, while it can be arranged inclined and preferably perpendicular to the cutting plane in the supply position. The slicing apparatus furthermore has a removal apparatus for removing portions that each comprise at least one cut-off product slice.

Such slicing apparatus are generally known. It is disadvantageous in conventional slicing apparatus that breaks can arise in the product stream due to the loading with new products. These interruptions are in particular disadvantageous when a packaging machine is connected downstream of the removal apparatus. The shorter the products to be sliced, the more frequently new products have to be introduced into the loading apparatus, i.e. the proportion of interruptions is comparatively high with shorter products. The same applies to the processing of different product types since a change of the product type makes another loading necessary. A requirement for individual tracks can furthermore result during loading due to products of different lengths. The loading requirements for individual tracks can only be determined with difficulty, if at all, with a higher ranking cycle.

The interruptions in the product stream result in the use of buffer apparatus, in particular in the region of the conveying and/or sorting lines that are connected downstream of the slicing unit. The total length of a plant of supply apparatus, slicing unit and removal apparatus is extended by the buffer apparatus. The size of the plant can, however, possibly represent a problem since the plants are typically operated in closed-off rooms due to the required hygiene and since the integration into existing routines and plant parts may possibly be made more difficult.

DE 10 2012 109 247 A1 discloses an apparatus and a method for a continuous production of portions. In this respect, a separate track is provided for each food product for the slicing of a plurality of food products, with the food product being transported along said separate track in the direction of a blade. Each track can in this respect be adjusted from a loading position into a supply position independently of the other tracks.

The adjustment of the respective total track, including the conveying means decisive for the exact product feed to the blade, is disadvantageous in this arrangement. All technical measures for an autonomous operation of the respective track must therefore be provided both for the supply position and the loading position over the total track length. The conveying means thus respectively extends over the total track length. Each track furthermore requires a lifting apparatus.

In addition, the center of rotation position together with the reception in the proximity of the cutting plane becomes difficult with respect to the construction effort and the accessibility since a spacing thereby results between the conveying means and the blade.

The removal of end pieces upstream of the blade is furthermore not possible using conventional methods due to the conveying means continuing from the blade or from the cutting edge up to and into the loading region.

A relatively long machine arrangement results overall when upstream supply devices are included with which the products are also associated with a track in the transverse direction before the entry into the vertically movable individual tracks.

It is therefore an object of the invention to provide an apparatus and a method for slicing products that do not show the disadvantages of the prior art.

This object is satisfied by an apparatus and by a method having the features of the independent claims.

In accordance with the invention, the loading apparatus as a whole is adjustable between the loading position and the supply position. All loading tracks of the loading apparatus can in particular only be adjusted together. Such a loading apparatus can be manufactured and serviced at considerably less expense than a loading apparatus having individually adjustable loading tracks.

The supply apparatus comprises at least one conveying apparatus that is connected downstream of the loading apparatus viewed in the supply direction and that has at least two conveying tracks. The number of conveying tracks is generally as desired. If, for example, two conveying tracks are provided, a product is sliced in one conveying track and the other conveying track is loaded. With more than two conveying tracks, a product can be sliced in at least one conveying track and at least one other track can be loaded.

The number of removal tracks of the removal apparatus is also generally as desired. The number of removal tracks can preferably correspond to the number of conveying tracks. This can in particular be the case in a region into which the cut-off product slices move after the cutting off by the slicing unit. The number of removal tracks can in particular be reduced by at least one removal track after a portioning region in which the cut-off slicers are combined to form portions. For example, four conveying tracks can be provided and, after a portioning region, three removal tracks.

Part portions are also to be understood under the term of portions that can, for example, be led together by a part portion that originally comes from a different conveying track to form a common portion. This is in particular the case when a product in a conveying track is no longer sufficient to form a complete portion. The part portion that is created can then, for example, be supplemented by product slices or by a part portion from a different conveying track.

In accordance with the invention, the conveying apparatus is not identical to the loading apparatus. The conveying apparatus is preferably arrangeable or arranged directly before the slicing unit. The conveying apparatus can in particular provide the product feed in slicing operation. It is in particular advantageous in this respect if the conveying apparatus reaches as close as possible to the slicing unit, preferably to the circular blade or scythe-like blade. An end region of the products can in particular be securely held and conveyed in this manner.

The conveying apparatus preferably works independently of the loading apparatus. The loading apparatus can thus in particular be adjustment relative to the conveying apparatus between an at least substantially horizontal loading position and an inclined supply position without influencing the conveying apparatus. The conveying apparatus itself can preferably be permanently arranged in a slanted or inclined position. The conveying apparatus is therefore in particular permanently in the supply position.

The supply position comprises a control apparatus that is configured to control the conveying tracks independently of one another such that portions are produced continuously in that the cutting off of product slices is interrupted in one conveying track and the cutting off of product slices is started in a different conveying track, in particular almost simultaneously, e.g. within a maximum of 2, 1, 0.5, 0.25 or 0.1 seconds.

The supply apparatus in particular or alternatively comprises a control apparatus that is configured to control the conveying tracks independently of one another such that portions are continuously produced in that a product is sliced in one conveying track until a predefined criterion is satisfied before the cutting off of products slices is started in a different conveying track. The criterion can be satisfied, for example, when the product has been completely sliced. The criterion can also relate to the reaching of a specific product region. A region is, for example, conceivable having a specific contour and/or structure that would not produce any uniform product slices, e.g. a fatty or irregularly shaped region. The criterion can in particular be satisfied when an end region of a product is reached.

A first cut or a slicing of a residual piece in this respect does not correspond to a cutting off of product slices. Only such slices, in particular only such complete slices, are considered to be product slices that are suitable for forming a portion.

The slicing of a product is therefore first interrupted, preferably when it has been completely sliced, before the slicing of the next product is started in a different conveying track. In this sense, the products are sliced alternately, in particular completely, in the conveying tracks in that they are supplied on individual tracks. Unlike the prior art, the loading apparatus in accordance with the invention that is pivotable in one part supplies all the conveying tracks with the aid of a single lifting or pivoting apparatus. This substantially reduces the construction effort with respect to means using individual tracks for a movement in the vertical direction.

In accordance with the invention, a new product can thus be loaded into the loading apparatus while a previous product is supplied to a slicing unit by the conveying apparatus and is sliced. The newly placed in product can already be brought into a supply position independently of the other product such that the new product can be sliced as soon as the slicing procedure of the previous product on the other conveying track is interrupted.

At least one product can be permanently sliced in this manner. From the viewpoint of the slicing unit, it is thus so-to-say an improved single-track operation with the aid of a multi-track product supply. This has the result that buffer lines can be very short or can be dispensed with completely. The total plant can therefore be comparatively compact.

Portions that can be supplied to a packaging machine in a product stream without interruption can subsequently be formed form the product slices continuously cut off from the products.

The apparatus in accordance with the invention and the method in accordance with the invention are in particular especially advantageous in the slicing of foods of different types or of short products since loading breaks typically occur relatively frequently in this respect, the conveying stream is interrupted often and has to be homogenized using additional measures.

Further developments of the invention can also be seen from the dependent claims, the description and the enclosed drawings.

In accordance with an embodiment, the loading apparatus extends at least substantially over the width of at least one conveying track and is configured to bring a product to a predefinable or predefined conveying track.

The predefinable conveying rack can preferably satisfy a specific criterion. The criterion can, for example, comprise the corresponding conveying track not being occupied by a product and therefore requesting a product for the further slicing operation. Provision can, for example, also be provided to load the conveying tracks alternately with products as uniformly as possible in order e.g. to keep the wear comparable in all the conveying tracks and/or to homogenize it somewhat at the blade periphery of the cutting blade. Alternatively, individual conveying tracks can e.g. at least temporarily not be loaded with products to service or clean these conveying tracks, for example.

A product can consequently be conveyed through the loading apparatus on a specific conveying track, that is, for example, only in the supply direction, if the product is already located at the correct position on the loading apparatus. A movement in the transverse direction is furthermore also possible, however, to bring a product located on the loading apparatus to a corresponding conveying track.

In accordance with a further embodiment, the loading apparatus extends at least substantially over the width of all conveying tracks. The loading apparatus is configured to bring a product to a predefinable or predefined conveying track.

The loading apparatus can in this respect in particular only be adjusted in the supply direction or both in the supply direction and in the transverse direction. A tilting of the loading apparatus about a longitudinal axis is e.g. furthermore possible. A product located on the loading apparatus can in this respect so-to-say roll off at a predefined side of the loading apparatus.

The loading apparatus preferably comprises a single, wide conveyor belt that extends over the total width of the conveying apparatus. Alternatively the loading apparatus can comprise a sliding surface or can be of a belt type, with in this case products holder being able to provide a feed on individual tracks.

In accordance with a further embodiment, the loading apparatus comprises a plurality of loading tracks. The number of loading tracks is generally as desired.

The number of loading tracks preferably corresponds to the number of conveying tracks. The term tracks is to be understood broadly in the sense of the invention. The individual tracks do not have to be physically separate from one another. The loading apparatus can therefore also in particular comprise a single wide conveyor belt on which there is space for at least two products arranged next to one another. The region that is provided for a product can in this respect be considered a track.

If the loading apparatus comprises a single, wide conveyor belt that e.g. extends over the total width of the conveying apparatus, this wide conveying track can also have a plurality of loading tracks, i.e. regions for different products. A product can be placed or conveyed on a specific loading track during loading that corresponds to an extension of the associated conveying track. Such a product can consequently, for example, be supplied directly to a corresponding conveying track without a transverse adjustment of the loading apparatus.

It is furthermore also possible that the product is placed or conveyed on any desired loading track. The loading apparatus, in particular a conveyor belt of the loading apparatus, can subsequently be tilted about the longitudinal axis, for example, or can be adjusted transversely to the supply direction so that the product moves onto a specific loading track or ultimately onto a specific conveying track. In this respect, the loading apparatus can in particular comprise a longitudinally and transversely movable conveying apparatus.

Alternatively, the loading tracks can in particular be controlled independently of one another. In this case, the loading apparatus is also physically divided into a plurality of loading tracks. The loading tracks can, for example, each be formed by a separate conveyor belt that is individually controllable with the aid of a control apparatus.

The conveying speed of a loading track can coincide with the conveying speed of a corresponding conveying track during the transport of the product located in this loading track. The respective tracks can consequently in particular be cycled with respect to one another such that the product moves from the loading apparatus into the conveying apparatus without interruption.

In accordance with an alternative embodiment, the loading apparatus comprises a single loading track that is adjustable transversely to the supply direction. The loading apparatus can in this respect be at least as wide as a conveying track and can be of only single-track design. The single loading track can be transversely adjusted such that the product moves to an associated conveying track. The transversely adjustable loading apparatus is therefore in particular also able to receive a product at the supply side at any desired position on a region travelable in the transverse direction.

In accordance with a further embodiment, the conveying apparatus comprises sliding surfaces, passive conveyor belts and/or active conveyor belts, with a product holder in particular being provided for each conveying track. Grippers for the end pieces and tractor belts acting on the product from above can, for example, belong to these known means to guide especially the end region of products. The product feed thus e.g. takes place at least by one product holder. The conveying apparatus in this respect in particular serves for the infeed of a product into a slicing procedure.

The conveying apparatus can comprise a support of any desired design. It can in particular be a case of sliding surfaces. The product can in this respect e.g. be moved over the sliding surface by means of a product holder and/or of an upper tractor.

Passive conveyor belts, i.e. non-driven conveyor belts, can alternatively also be provided. The product can in this respect, for example, also be moved over the conveyor belt to the slicing unit by a product holder and/or upper tractor.

Active conveyor belts, i.e. driven conveyor belts, that transport the product to the slicing unit are furthermore also conceivable. In this respect, a product holder and/or upper tractor can in particular additionally be provided for the transport of the product.

The product holder can preferably be configured as a gripper that engages into an end region of a product. An almost completely sliced product can also be stabilized and reliably supplied to the slicing unit in this manner. A remaining residual piece can subsequently be removed from the gripper.

In accordance with a further embodiment, the conveying apparatus has a smaller length than the loading apparatus in the supply direction. The conveying apparatus can in particular have a maximum of 60%, 50% or 40% of the length of the loading apparatus. The length of the conveying apparatus can preferably amount to a maximum of 700 mm, 600 mm, 500 mm, 350 mm or 300 mm. The conveying device can thus in particular be shorter than a not yet sliced product.

In accordance with a further embodiment, the removal apparatus comprises a discarding apparatus having a plurality of removal tracks, wherein the number of removal tracks corresponds to the number of conveying tracks and wherein the removal tracks are controllable independently of one another. Product scraps that are produced during the cutting off of a product front end can thus be discarded on individual tracks, for example. The discarding apparatus can, for example, be a rocker and/or a conveyor belt movable opposite to the supply direction.

In accordance with a further embodiment, the removal apparatus comprises a distributor device that is configured for leading together portions or product slices from different conveying tracks. The product slices sliced in different conveying tracks can thus be grouped into portions and can be subsequently led together to ensure a continuous product stream or portion stream, for example to a packaging apparatus. The distributor device can, for example, lead together two removal tracks to one removal track or also four removal tracks to two removal tracks. The product slices or part portions from different removal tracks can also be placed over one another, for example, e.g. to form multi-type portions.

The invention moreover relates to a method for a continuous slicing of products, in particular food products, using a slicing apparatus, in particular a high performance slicer, having at least one slicing unit, in particular having a circular blade or scythe-like blade, for cutting off product slices. The slicing apparatus comprises a supply apparatus for a multi-track supply of products to the slicing unit and a removal apparatus for a removal of portions that each comprise at least one cut-off product slice. The supply apparatus comprises a loading apparatus that is configured for receiving at least one product and is adjustable as a whole between a loading position and a supply position and comprises at least one conveying apparatus that is connected downstream of the loading apparatus in the supply direction and has at least two conveying tracks.

A first product is supplied on a first conveying track. The loading apparatus is adjusted into the loading position when the first product has at least substantially left the region of the loading apparatus. The first product can in this respect, for example, also project somewhat over the rear region of the conveyor apparatus.

The loading apparatus is subsequently loaded with at least one second product and the total loading apparatus having the second product is adjusted into the supply position. The second product is then supplied on a second conveying track.

The method can be repeated or continued as desired. In this respect, from a nomenclature aspect, the second product takes the place of the first product and a new product takes the place of the second product.

Right at the start of a working cycle, i.e. at the start of the slicing procedure on the putting into operation of the supply apparatus, more than one conveying track can also be loaded with products such that the first cut can first be removed from all products. The slicing itself, however, then takes place consecutively again, i.e. the slicing of a product is only started when the other product has been sliced. The loading takes place after this initial phase in accordance with the just-described process, i.e. a new product is loaded into the loading apparatus while the preceding product is just being sliced.

In accordance with a further embodiment, the loading of a loading apparatus comprising a plurality of loading tracks with the second product takes place in a loading track that differs from the loading track of the first product. The product is thus in particular loaded into a loading track in which there is currently no product that is being sliced, also in an extension thereof, that is in the corresponding conveying track. The loading of the loading tracks can thus preferably take place alternately.

In accordance with an alternative embodiment, after the loading of a loading apparatus comprising a single loading track, the former is adjusted transversely to the supply direction such that the second product moves to the second conveying track. A further product can consequently move to a conveying track on which a product demand is present. The loading track is in this respect adjusted transversely such that it corresponds to the extension of an associated conveying track.

In accordance with an embodiment, the loading apparatus is loaded with at least two products and is adjusted into the supply position, wherein first one product is sliced before the cutting off of product slices from another product is started. The loading apparatus is adjusted into the loading position when the other product has at least substantially left the region of the loading apparatus. A plurality of products are preferably always loaded together into the loading apparatus, i.e. a plurality of loading tracks are simultaneously occupied. The products are adjusted into the supply position together. A product is subsequently sliced, for example completely or until a predefined criterion is satisfied. The other product can already be supplied to the slicing unit while the one product is being sliced in order in particular to remove a product front end. Alternatively, the other product can also only be supplied when the one product is no longer being sliced, that is, for example, has been completely sliced or a predefined criterion has been satisfied. The loading apparatus is in particular only adjusted into the loading position when both products have at least substantially left the region of the loading apparatus.

In particular or alternatively, two products can always be transported onto the loading apparatus and can be raised into the cutting position, i.e. into the supply position, wherein the first product is first sliced and then the second product is supplied to the slicing unit. The loading apparatus is then lowered for a subsequent loading when the second product has left it, at least largely.

In accordance with a further embodiment, the product front end of the second product is cut off, in particular by means of the slicing unit, before the first product has been completely sliced. The second product is already ready for slicing in this manner when the first product has been completely sliced. It is therefore possible to start the slicing of the second product without interruption. This allows a continuous production of product slices or portions.

In accordance with a further embodiment, product scraps produced on the cutting off of the product front end are discarded from the removal apparatus on individual tracks via a discarding apparatus. The product scraps have thus already been removed when the actual slicing of the product is begun. A rocker divided over individual tracks can be provided for this purpose for a removal in the conveying direction. If, in contrast, cut product residues are removed against the conveying direction, a portioning belt divided over individual tracks is advantageous. This can in particular briefly run in the opposite direction.

In accordance with a further embodiment, portions that come from different conveying tracks are led together with the aid of a distributor device. Portions from originally two or more conveying tracks can thus, for example, be brought onto a single removal track. A continuous product stream without interruptions is ensured in this manner.

The portions can e.g. also be part portions, that is incomplete desired portions that can be led together with another part portions and can thus be completed. A portion that comprises a total of ten product slices can, for example, be formed from the last six slices of a product and the first four slices of another product. The product slices and/or portions of different conveying tracks can in particular be placed over one another.

It is also possible to carry out a cutting head adjustment, in particular a vertical and/or lateral adjustment. An adjustment of the cutting head is advantageous since is can occur, depending on the cutting operation on one or the other track, that the position of e.g. the angle of incidence, of the cutting blade, in particular of the cutting edge, is not ideal with respect to the product. The blade position can preferably be optimized during a change phase before a track conversion. A cutting head adjustment can thus take place, for example, on the creation of a last portion from a product. In this respect, blank cuts can be used, for example, that are carried out for the transporting away of the last portion of the one portion or of the first portion of the other track. A gradual adjustment is thus in particular achieved, in particular during the blank cuts.

All the embodiments of the apparatus described here are in particular configured to be operated in accordance with the method described here. Furthermore, all the embodiments of the apparatus described here as well as all the embodiments of the method described here can each be combined with one another.

The invention will be described in the following by way of example with reference to the drawings. There are shown:

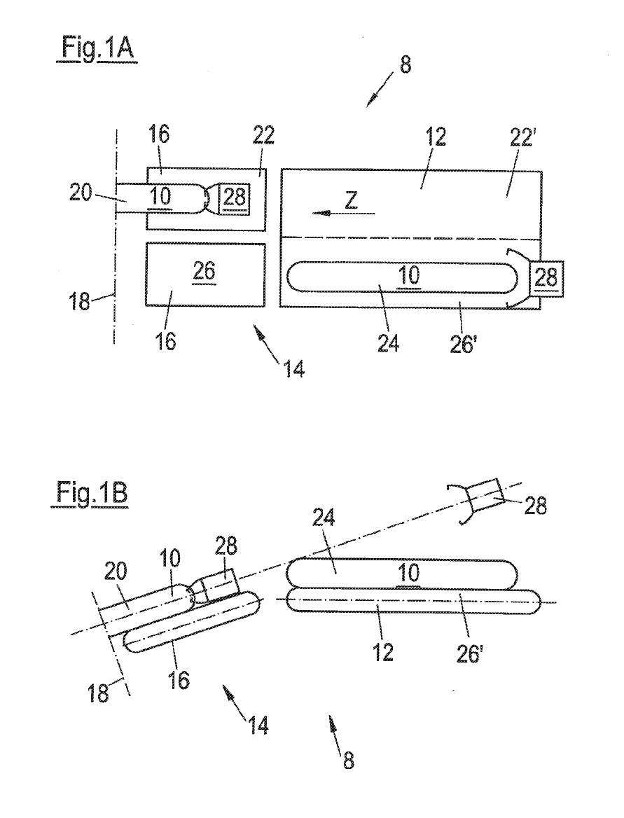

FIG. 1A to FIG. 4B schematically, respective plan views or side views of a first embodiment of a supply apparatus of a slicing apparatus in accordance with the invention;

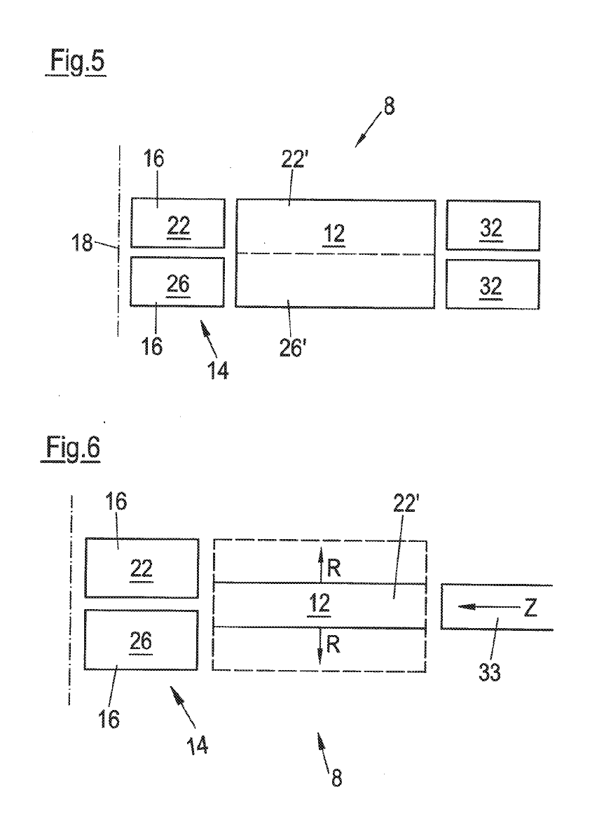

FIG. 5 schematically, a plan view of a second embodiment of a supply apparatus of a slicing apparatus in accordance with the invention;

FIG. 6 schematically, a plan view of a third embodiment of a supply apparatus of a slicing apparatus in accordance with the invention;

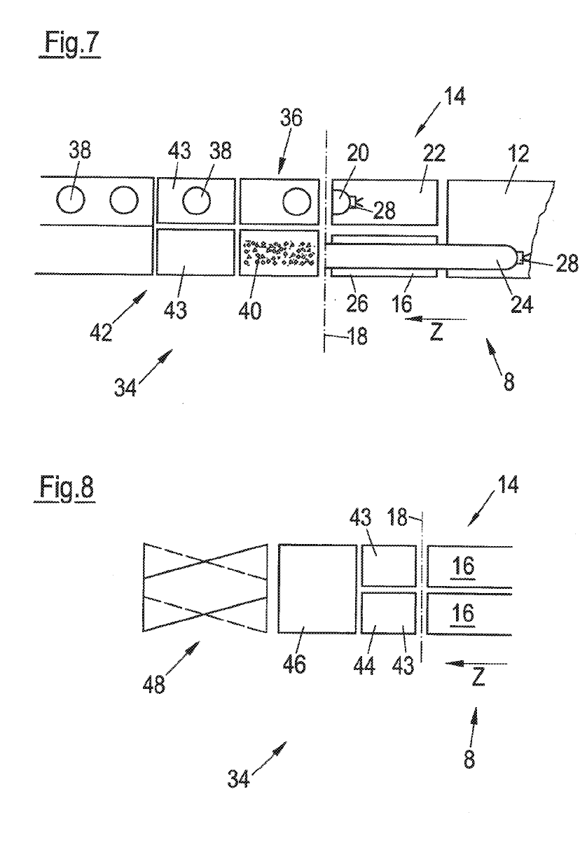

FIG. 7 schematically, a plan view of a first embodiment of a removal apparatus of a slicing apparatus in accordance with the invention;

FIG. 8 schematically, a plan view of a second embodiment of a removal apparatus of a slicing apparatus in accordance with the invention; and

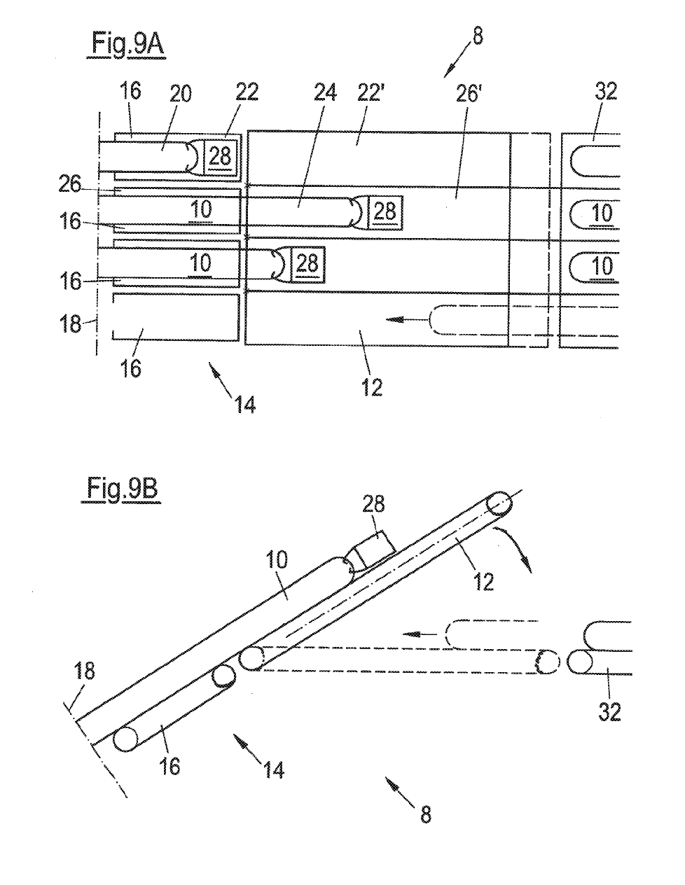

FIG. 9A and FIG. 9B schematically, a plan view and a side view of a fourth embodiment of a supply apparatus of a slicing apparatus in accordance with the invention.

It must first be noted that the embodiments shown are of a purely exemplary nature. The number of tracks and conveyor units shown can in particular vary. The features of an embodiment can also be combined as desired with features of another embodiment. Any desired supply apparatus can in particular be combined with any desired removal apparatus.

A supply apparatus 8 of a slicing apparatus is shown in FIGS. 1A to 4B. The supply apparatus 8 is configured for a multi-track supply of food loaves 10 that represent the conveyed products.

The supply apparatus 8 comprises a loading apparatus configured as a wide belt conveyor 12 and a conveying apparatus 14 having two conveyor belts 16 that are controllable independently of one another.

A slicing unit 18 of which only the cutting plane is shown in dashed lines adjoins the conveying apparatus 14. The slicing unit 18 can comprise one or more cutting blades, in particular circular blades or scythe-like blades, depending on the application. If products 10 of different types are sliced, different cutting blades can in particular be used for the respective product types.

Both the loading apparatus 12 and the conveying apparatus 14 are each divided into two respective tracks, i.e. part regions. A first product 20 is arranged on a first conveying track 22 of the conveying apparatus 14 in FIG. 1A. A second product 24, in contrast, is positioned on a second loading track 26′ of the loading apparatus 12 differing from the first conveying track 22. A respective product holder 28 engages into both product ends.

As can be seen in FIG. 1A, the belt conveyor 12 is approximately as wide as the conveying apparatus 14. The conveyor belts 16 of the conveying apparatus 14 are considerably shorter than the conveyor belt 12. As can be seen in the side view in accordance with FIG. 1B, the conveyor belts 16 are set permanently slanted and are at a right angle to the cutting plane of the slicing unit 18. The belt conveyor 12, in contrast, can be adjusted from a horizontal loading position into a slanted supply position.

The second product 24 is provided on the belt conveyor 12 in the second loading track 26′ while the first product 20 in the first conveying track 22 is still being supplied to the slicing unit 18 in the supply direction Z. The belt conveyor 12 is in this respect located in the loading position. A food loaf 10 can be permanently located on the belt conveyor 12 in this manner. The choice as to which of the loading tracks 22′, 26′ is loaded in this respect depends on the demands of the conveying apparatus 14. In principle, a loading track 22′, 26′ is thus always loaded in which the corresponding conveying track 22, 26 of the conveyor belt 16 connected downstream is not already occupied by a preceding food loaf 10 and in which the product holder 28 is again retracted so far in the upstream direction that a product 10 can be conveyed past it into the provided conveying track 22, 26.

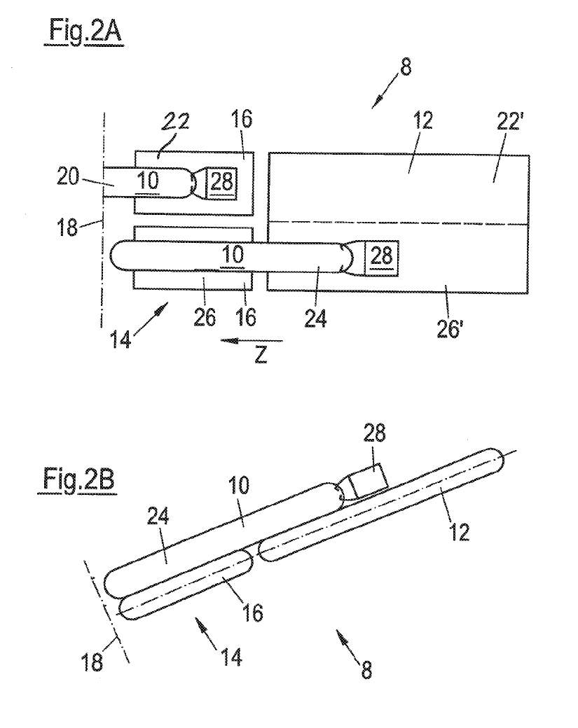

In FIG. 2A and FIG. 2B, the belt conveyor 12 was adjusted from the loading position into the supply position. The second product 24 in the second loading track 26′ and in the second conveying track 26 can now be conveyed to the slicing unit 18 in the supply direction Z by a control apparatus, not shown, with the aid of a belt conveyor 12 and of the conveyor belt 16.

The start of the second product 24 is cut off while the first product 20 is still being sliced. In this manner, the second product 24 is prepared for the actual slicing procedure in which complete product slices are cut off.

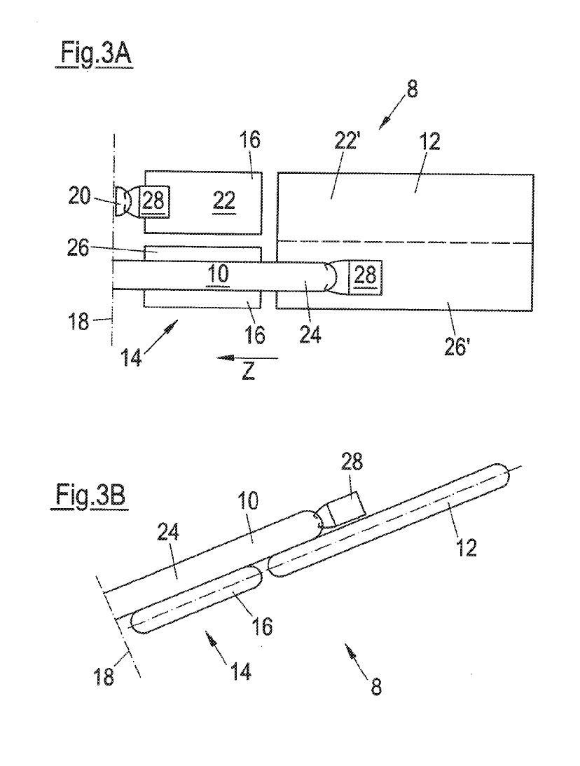

As is shown in FIG. 3A and FIG. 3B, the actual slicing procedure of the second product 24 only starts when the first product 20 has been completely sliced. A continuous product stream results in this manner.

The product residue of the first product 20 can be removed from the gripper 28. The product residue can, for example, then be removed downwardly through a gap between the loading apparatus 12 and the conveying apparatus 14.

The belt conveyor 12 can now again be adjusted from the supply position into the loading position. This can also be done when the end region of the food loaf 10 guided at the product holder 28 still projects somewhat over the region of the belt conveyor 12.

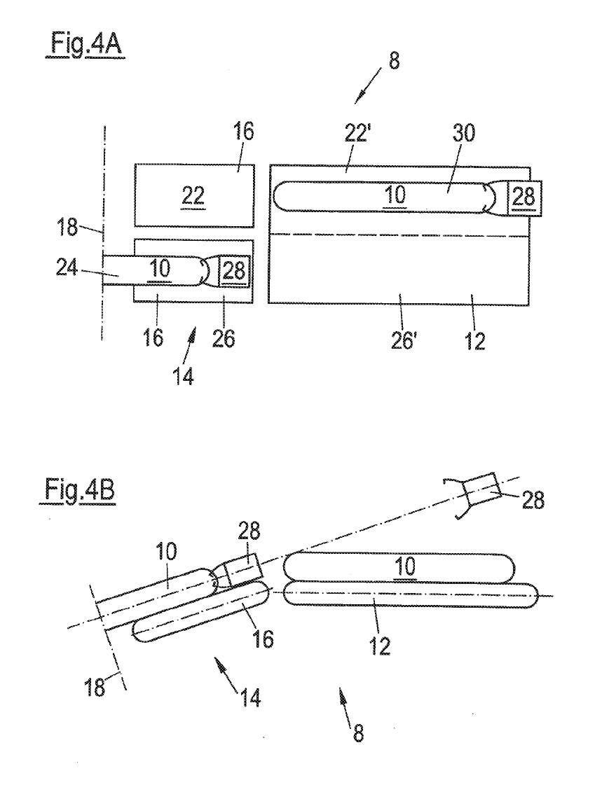

In accordance with FIG. 4A and FIG. 4B, a third product 30 is now loaded into the first loading track 22′ of the belt conveyor 12 while the second product 24 is sliced in the second conveying track 26.

In accordance with the invention, a switch can thus be made after the ending of a slicing procedure of one food loaf 10 to the slicing of a further food loaf 10 without any real interruption.

The loading of the belt conveyor 12 can take place manually or automatically. On a manual filling, the side or the loading track 22′, 26′ on which a new food loaf 10 is to be placed can be displayed to the operator, for example, by mechanical aids such as metal guide sheets, flaps and/or shields and/or visual aids such as display apparatus. The manual loading and placing of products onto a loading table that is connected upstream of the loading apparatus 12 is not shown, but can be carried out in a similar manner. Above-described aids can also be used for this purpose.

An automatic loading can be implemented, for example, by means of an apparatus shown in FIG. 5. Supplied food loaves 10 can be supplied to the desired loading track 22′, 26′ via two infeed belts 32. Supply belts, not shown, can be arranged before the infeed belts 32, wherein the food loaves 10 can generally be conveyed to the infeed belts 32 in a multi-track manner. The food loaves 10 can, for example, originate from a skinning machine or can also be placed onto the infeed belts 32 by hand.

In accordance with FIG. 6, the distribution only takes place by the belt conveyor 12 itself. The belt conveyor 12 is in this respect transversely displaceable in an adjustment direction R. A food loaf 10 located on the belt conveyor 12 can thus be supplied to the first conveying track 22 or to the second conveying track 26 depending on the track demand. The food loaf 10 can in this respect be placed directly into the belt conveyor 12 or can be supplied with the aid of a conveyor belt 33 connected upstream. The conveyor belt 33 connected upstream can, for example, be displaced in parallel with a longitudinal machine axis and thus does not necessarily have to control the belt conveyor 12 centrally. A lateral loading of the loading apparatus 12 is equally conceivable, but not shown, when the conveyor belt 33 reaches laterally to the side thereof and food loaves 10 are transferred from there.

The loading apparatus 12 can be adjusted as a whole relative to a frame of the loading apparatus 12. Alternatively, only individual components, e.g. laterally displaceable shafts, belts or a conveyor belt unit, can also be adjusted. The transverse displacement preferably takes place in the loading position.

Parallel lateral guides are furthermore preferably conceivable. A food loaf 19 can be placed between them and can then be moved or displaced, for example on a relatively smooth surface of the loading apparatus 12, laterally up to and in front of a requesting conveying track 22, 26.

Alternatively, a band-like loading apparatus 12 is also conceivable to fix and to transversely transport a food loaf 10.

A slicing apparatus in accordance with the invention is shown in FIG. 7 having a supply apparatus 8, a slicing unit 18 and a removal apparatus 34. The removal apparatus 34 can comprise portioning belts and/or control belts that can be of single-track, dual-track or multi-track design. A dual-track variant is shown in which a portioning and weighing apparatus 36 having separate weighing belts follows on from the slicing unit 18. A common weighing belt for both tracks would also be conceivable. It can in particular be determined with the aid of the portioning and weighing apparatus 36 whether complete product slices and/or portions 38 have been cut off from which portions 38 are formed or only product scraps 40. If product scraps 40 were cut off, they can subsequently be discarded from the product stream or portion stream via a discarding apparatus 42, in particular a rocker, connected downstream. If a rocker is used for the discarding of the product scraps 40, it can be arranged in an individual removal track 43.

The product front end of a new product 10 can already be cut off in this manner while the preceding product 10 is still being sliced.

Provided that the portioning and weighing apparatus 36 is formed transversely movably between the tracks, it is also possible to complete incomplete portions that are produced in a first track on an adjacent track with the start of slicing operation there.

A further possible arrangement downstream of the slicing unit 18 is shown in FIG. 8. A cross-distributor 48 as a distributor device follows after a portioning belt 44 and a control belt 46. A multi-track product stream or portion stream can, for example, be led together into a single removal track 43 with the aid of a cross-distributor 48.

It is possible by the cross-distributor 48 that a continuous conveying stream is maintained up to the packaging machine or up to a transport point, e.g. a feeder.

The discarding of product scraps 40 takes place in the embodiment in accordance with FIG. 8 by driving the portioning belts 44 against the actual conveying direction. It is thus possible by the divided embodiment of the portioning belt 44 respectively associated with a track to remove product scraps 40 in one track while slicing is still being carried out in another track.

A supply apparatus 8 having four parallel tracks is shown in FIGS. 9A and 9B. The products 10 are supplied to the conveying apparatus 14 of the slicing unit 18 and are sliced. Once these products 10 have at least substantially left the region of the loading apparatus 12 and once a product 10 has been completely sliced in at least one conveying track 22, 26 and the conveying track 22, 26 is thus empty, the loading apparatus 12 can be adjusted into the loading position to receive a new product 10 from the infeed belt 32.

### REFERENCE NUMERAL LIST

8 supply apparatus

10 food loaf, product

12 belt conveyor, loading apparatus

14 conveying apparatus

16 conveyor belt

18 slicing unit

20 first product

22 first conveying track

22′ first loading track

24 second product

26 second conveying track

26′ second loading track

28 product holder

30 third product

32 infeed belt

33 conveyor belt

34 removal apparatus

36 portioning and weighing apparatus

38 portion

40 product scrap

42 discarding apparatus

43 removal track

44 portioning belt

46 control belt

48 cross-distributor, distributor device Z supply direction

R adjustment direction

1.-16. (canceled)

17. A slicing apparatus for a continuous slicing of products, comprising
at least one slicing unit for cutting off product slices;
a supply apparatus for a multi-track supply of products to the slicing unit; and
a removal apparatus for removing portions that each comprise at least one cut-off product slice,
wherein the supply apparatus comprises
a loading apparatus that is configured for receiving at least one product and is adjustable as a whole between a loading position and a supply position;
at least one conveying apparatus that is connected downstream of the loading apparatus viewed in the supply direction and that has at least two conveying tracks; and
a control apparatus that is configured to control the conveying tracks independently of one another such that portions are produced continuously in that the cutting off of product slices is interrupted in one conveying track and the cutting off of product slices is started in another conveying track.

18. The slicing apparatus in accordance with claim 17,
wherein the cutting off of product slices is started almost simultaneously in another conveying track.

19. The slicing apparatus in accordance with claim 17,
wherein the loading apparatus extends at least substantially over the width of at least one conveying track and is configured to bring a product to a predefinable conveying track.

20. The slicing apparatus in accordance with claim 17,
wherein the loading apparatus extends at least substantially over the width of all the conveying tracks and is configured to bring a product to a predefinable conveying track.

21. The slicing apparatus in accordance with claim 17,
wherein the loading apparatus comprises a plurality of loading tracks, with the number of loading tracks corresponding to the number of conveying tracks.

22. The slicing apparatus in accordance with claim 21,
wherein the loading tracks are controllable independently of one another.

23. The slicing apparatus in accordance with claim 17,
wherein the loading apparatus comprises a single loading track that is adjustable transversely to the supply direction.

24. The slicing apparatus in accordance with claim 17,
wherein the conveying apparatus comprises sliding surfaces, passive conveyor belts and/or active conveyor belts.

25. The slicing apparatus in accordance with claim 24,
wherein a product holder is provided for each conveying track.

26. The slicing apparatus in accordance with claim 17,
wherein the conveying apparatus has a smaller length than the loading apparatus in the supply direction.

27. The slicing apparatus in accordance with claim 17,
wherein the removal apparatus comprises a discarding device having a plurality of removal tracks, with the number of removal tracks corresponding to the number of conveying tracks and with the removal tracks being controllable independently of one another.

28. The slicing apparatus in accordance with claim 17,
wherein the removal apparatus comprises a distributor device that is configured for leading together portions from different conveying tracks.

29. A method for a continuous slicing of products using a slicing apparatus, the slicing apparatus comprising
at least one slicing unit for cutting off product slices;
a supply apparatus for a multi-track supply of products to the slicing unit; and
a removal apparatus for removing portions that each comprise at least one cut-off product slice,
wherein the supply apparatus comprises
a loading apparatus that is configured for receiving at least one product and is adjustable as a whole between a loading position and a supply position; and
at least one conveying apparatus that is connected downstream of the loading apparatus viewed in the supply direction and that has at least two conveying tracks, wherein the method comprises the following steps:
supplying a first product on a first conveying track;
adjusting the loading apparatus into the loading position when the first product has at least substantially left the region of the loading apparatus;
loading the loading apparatus with at least one second or further product;
adjusting the loading apparatus into the supply position; and
supplying the second or further product on a second or further conveying track.

30. A method in accordance with claim 29,
wherein the loading of a loading apparatus comprising a plurality of loading tracks with the second or further product takes place in a loading track that differs from the loading track of the first product.

31. A method in accordance with claim 29,
wherein, after the loading of a loading apparatus comprising a single loading track, the former is adjusted transversely to the supply direction such that the second product moves to the second or further conveying track.

32. The method in accordance with claim 29,
wherein the loading apparatus is loaded with at least two products and is adjusted into the supply position, with one product first being sliced before the cutting of product slices from the other product is started, and with the loading apparatus being adjusted into the loading position when the other product has at least substantially left the region of the loading apparatus.

33. The method in accordance with claim 29,
wherein the product front end of the second or further product is cut off before the first product has been completely sliced.

34. The method in accordance with claim 33,
wherein the product front end of the second or further product is cut off by means of the slicing unit before the first product has been completely sliced.

35. The method in accordance with claim 33, wherein
product scraps produced on the cutting off of the product front end are discarded from the removal apparatus via a discarding apparatus individually for the tracks.

36. The method in accordance with claim 29,
wherein portions that come from different conveying tracks are led together with the aid of a distributor device.
